(19) United States
(12) Patent Application Publication
(10) Pub. No.: US 2006/0242062 A1
(43) Pub. Date: Oct. 26, 2006

(54) Remote check deposit

(76) Inventors: David L. Peterson, Hahira, GA (US); Ronnie Paul McCulloch, Brentwood, TN (US)

Correspondence Address: Paul E. Schaafsma;NovusIP, LLC, Suite 221, 521 West Superior, Chicago, IL, 60610, US

(21) Appl. No.: 11/114,254

(22) Filed: Apr. 26, 2005

(51) Int. Cl. G06Q 40/00

(52) U.S. Cl. 705/42; 705/43; 705/45

(57) ABSTRACT

In accordance with the principles of the present invention, a system is provided for capturing a customer deposit at their place of business, converting the Magnetic Ink Character Recognition (MICR) data encoded documents into an image with an associated data file, and electronically transmit the data to a financial institution. The system allows the customer to scan each MICR encoded check that is to deposited with their financial institution, which captures financial institution routing information and customer account information. The associated image the physical check can be franked denoting the check has been electronically processed to avoid further processing. The resulting image and account data can then be processed by the financial institution. There are three options for encoding the amount: 1) the customer enters each amount after scanning the item prior to sending to the financial institution; 2) the financial institution enters the amount of each item after receiving the file from the customer; and 3) the amount field(s) are scanned and the amount is automatically entered. The system allows for both 1) online (Internet) capture of the MICR data and the associated image or 2) offline capture and the subsequent importing of the image and MICR data for transmission to the financial institution via the Internet. The financial institution can review the items captured online, and repair any item that is incorrect. The financial institution can use the system to print substitute checks that confirm to ANSI X9.90 for processing or deliver an electronic file in ANSI X9.37 format to any check processing system. The system includes secure transport over Internet connections for file transfer and dual control security to reduce fraudulent transactions from being initiated by the customer.

### FIELD OF THE INVENTION

The present invention relates to remote check deposits.

### BACKGROUND OF THE INVENTION

Every day, business customers deposit thousands of paper checks in financial institutions by physical deposits. Business accounts need to make deposits quickly and conveniently. Rushing to a branch is usually a hassle, even if only blocks away. In addition, because of the delay in depositing paper checks, business owners get feedback on bad checks too late to let them stop shipping an order before it reaches the offending customer.

The Federal Reserve System, often referred to as the Federal Reserve or simply “the Fed”, is the central bank of the United States. It was created on 23 Dec. 1913 by Congress to provide the nation with a safer, more flexible, and more stable monetary and financial system. The Federal Reserve System is basically composed of a central, governmental agency—the Board of Governors—and twelve regional Federal Reserve Banks, located in major cities throughout the nation. The seven members of the Board of Governors are nominated by the President of the United States and confirmed by the U.S. Senate. The current Chairman of the Board of Governors is Alan Greenspan.

In 2000 the Federal Reserve Board staff began investigating a concept of default check truncation rules that is now called the Check Clearing for the 21^{st} Century Act or “Check 21”. The goals of the Check 21 initiative were to enable a financial institution to substitute a machine-readable copy of a check (a “Substitute Check”) for the original check for forward collection or return. These Substitute Checks would be the legal and practical equivalent of the original check.

On 21 Dec. 2001, Chairman Greenspan sent a legislative proposal to the Chairs and Ranking Members of the Senate and House Banking Committees. Both the House and Senate introduced bills in the 107^{th} Congress, and in the 108^{th} Congress the House introduced H.R. 1474 while the Senate introduced S. 1334. On 8 Oct. 2003 the Act passed House of Representatives unopposed. On 14 Oct. 2003, the Act was passed in the Senate by unanimous consent. President Bush signed the bill into law on 28 Oct. 2003. The effective date is 12 months after enactment, which was 28 Oct. 2004.

The Act only covers Substitute Checks. The “Substitute Check” couples the image of the original check with additional routing information. While Check 21 does not address check image formats or the electronic exchange and settlement of “Substitute Checks” rather than paper checks, Check 21 does make such image exchange and settlement possible by giving “Substitute Checks” the legal equivalency of the original checks they represent. Check 21 thus also makes possible a business' ability to remotely and electronically deposit checks with its financial institution.

Remote deposit is a business customer's ability to capture the images and transaction information of checks accepted for payment and the delivery of this information electronically to the financial institution in a format such that the checks can be processed as if the items had been physically received and captured. These electronic items can then be delivered to other financial institutions via an approved file format.

The Act facilitates electronic/image exchanges but electronic/image exchanges are not covered by the Act. The Act encourages the use of electronics by using images of checks to create Substitute Checks that are covered by the Act. The Act does not apply to truncation, safekeeping or image exchange systems which require agreement between the parties, for example, bank image statement services, credit union truncation, check image exchange processes. The Act creates a new legal instrument—the “Substitute Check”—that is the legal equivalent of the original paper check. The Substitute Check: can be processed exactly as if it were the original paper check; cannot be refused by parties wanting to receive paper checks, including other financial institutions, paying customers, depositing customers, consumers, corporations, Federal Reserve, processors, etc.; and is supported by warranties and indemnifications from the financial institution creating the Substitute Check to subsequent parties in collection and return processes.

The Act further creates a new consumer protection feature for those consumers that receive Substitute Checks. Should the consumer experience a loss because they received a Substitute Check that they would not have experienced if they had received the original check, the financial institution has 10 days after a consumer claim to research and credit the consumer's account for check amounts up to $2,500 per check. The availability can be withheld up to 45 days. Regulation CC Availability of Funds and Collections of Checks (12 C.F.R. § 229) originally issued by the Federal Reserve Board in September 1988. There are also expedited recredit procedures for financial institutions. There is no special provision for Treasury Checks.

In light of these legislative developments, what is needed is a system by which check truncation can be better facilitated. It would be desirable to foster innovation in the check payment system without mandating physical presentation of checks at a financial institution. It would be further desirable to improve the payment system overall.

### SUMMARY OF THE INVENTION

A system in accordance with the principles of the present invention better facilitates check truncation at the place where checks are first presented. A system in accordance with the principles of the present invention fosters innovation in the check payment system without mandating physical presentation of checks at a financial institution. A system in accordance with the principles of the present invention improves the payment system overall.

In accordance with the principles of the present invention, a system is provided for capturing a customer deposit at their place of business, converting the Magnetic Ink Character Recognition (MICR) data encoded documents into an image with an associated data file, and electronically transmitting the data to a financial institution. The system allows the customer to scan each MICR encoded check that is to be deposited with their financial institution, which captures financial institution routing information and customer account information. The associated image the physical check is franked denoting the check has been electronically processed to avoid further processing. The resulting image and account data can then be processed by the financial institution. There are three options for encoding the amount: 1) the customer enters each amount after scanning the item prior to sending to the financial institution; 2) the financial institution enters the amount of each item after receiving the file from the customer; and 3) the amount field(s) are scanned and the amount is automatically entered. The system allows for both 1) online (web) capture of the MICR data and the associated image or 2) offline capture and the subsequent importing of the image and MICR data for transmission to the financial institution. The financial institution can review the items captured online and repair any item that is incorrect. The financial institution can use the system to print substitute checks that confirm to ANSI X9.90 for processing or deliver an electronic file in ANSI X9.37 format to any check processing system. The system includes secure transport over Internet connections for file transfer and dual control security to reduce fraudulent transactions from being initiated by the customer.

### BRIEF DESCRIPTION OF THE DRAWINGS

FIG. 1 shows a non-limiting example of a hardware infrastructure that can be used to run the system of the present invention.

FIGS. 2a and 2b shows a FI Definition Add screen in accordance with the principles of the present invention.

FIG. 3 shows a FI Configuration screen in accordance with the principles of the present invention.

FIG. 4 shows a FI Deposit Slip Definition Add pop-up screen in accordance with the principles of the present invention.

FIG. 5 shows a Customer Definition Edit screen in accordance with the principles of the present invention.

FIG. 6 shows a Remote Deposit Definition Edit screen in accordance with the principles of the present invention.

FIG. 7 shows a FI User Detail screen in accordance with the principles of the present invention.

FIG. 8 shows a Financial Institution Administration Menu home page screen in accordance with the principles of the present invention.

FIG. 9 shows a Pickup Transactions—Remote Deposit screen in accordance with the principles of the present invention.

FIG. 10 shows a Business Central screen in accordance with the principles of the present invention.

FIG. 11 shows a Remote Deposit instruction screen in accordance with the principles of the present invention.

FIG. 12 shows a Remote Deposit form in accordance with the principles of the present invention.

FIG. 13 shows a Remote Deposit List screen in accordance with the principles of the present invention.

FIG. 14 shows a Remote Despite File Loan screen in accordance with the principles of the present invention.

FIG. 15 shows an Unauthorize Transactions screen in accordance with the principles of the present invention.

FIG. 16 shows a second Financial Institution Administration Menu home page in accordance with the principles of the present invention.

### DETAILED DESCRIPTION OF THE INVENTION

A system in accordance with the principles of the present invention equips a financial institution's business clientele with the ability to deposit checks remotely without physically depositing checks to a financial institution's branch location. A system in accordance with the principles of the present invention allows checks to be truncated electronically at the business site, deposited online, and picked up by the financial institution as a ‘Check 21 file’. The file may then be processed by any image exchange or check processing system or printed as a substitute check.

In accordance with the principles of the present invention, a business accesses the web using an Internet browser. A check scanner captures the image of the front and back of the check and the associated Magnetic Ink Character Recognition (MICR) data. Alternatively, a standalone scanning system can be used to capture check images and MICR data to create a “Check” file and the resulting file can be delivered for pickup by the financial institution.

In a first embodiment, if the amount field has not been encoded on the item, this amount is manually entered. In a further embodiment, a system in accordance with the principles of the present invention can capture the amount field(s) automatically from the scanned image and enter the amount. Multiple items can be “batched” and submitted for pickup by the financial institution. For customers that have their own scanning capability, the present invention will allow for a “Check 21” file in X9.37 format to be delivered through the secure web file delivery contained in the Web Client.

The present invention allows a remote deposit for capturing the check at the place of presentment and converting the image and related MICR data into the X9.37 format. The present invention further allows printing of Image Replacement Documents (IRDs) or Substitute Checks.

The X9.37 format is the current American National Standards Institute (ANSI) standard for electronic exchange of checks and check data among financial institutions and processors. The X9.37 format has been approved by the Federal Reserve Bank for combining check images and related check information into a single file. The Federal Reserve Bank version of the X9.37 file should be supported by all check processing vendors and third-party services.

Although Extended Binary Coded Decimal Interchange Code (EBCDIC) representation is approved by the Federal Reserve Bank and internally created files will be created in the EBCDIC text coding system, the present invention will permit an American Standard Code for Information Interchange (ASCII) text coding system representation to be a Pass Through file with or without validation. At the financial institution, the financial institution will pick up the resulting transactions/file(s) via an online (web) connection which allows individual or collective accumulation of the transaction data into an X9.37 formatted file. The resulting file can be saved to any location within the network of the online (web) access device where the financial institution is performing the file pickup.

The resulting files can be delivered to any internal Local Area Network (LAN)/Wide Area Network (WAN) directory, to be processed by the financial institution's check processing system or service. Since all check vendors will need to process files produced by the Federal Reserve, it is anticipated that every check vendor will offer an update to process the “Check 21” file types approved by the Federal Reserve.

Although the retention of images for access by the banks customers is not required for “Check 21” files, the present invention allows for images to be stored on the service, for example, up to seven (7) years. Access to the images is available via an option on the main menu, via an Internet connection.

While in the embodiment described herein the present invention is operated on the Web-based ACH origination service, Goldleaf Client, available from Goldleaf Technologies, 214 Overlook Ct., Suite 120, Brentwood, Tenn. 37027 USA, the principles of the present invention can be applied to other, alternative systems or as a stand-alone system.

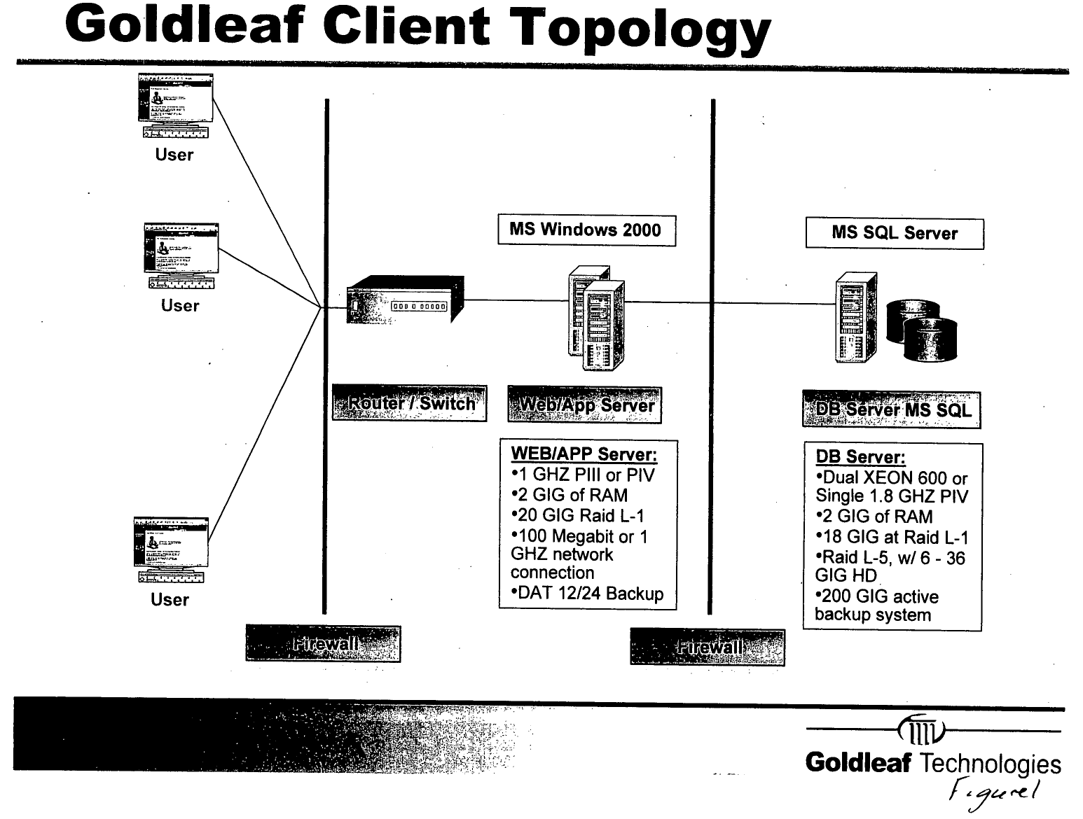

Referring to FIG. 1, a non-limiting example of a hardware infrastructure that can be used to run the system of the present invention is seen. The infrastructure preferably can include but is not limited to: Internet connectivity; network infrastructure; MS Windows NT or 2000 network available from Microsoft Corporation, Redmond, Washington; firewall(s); Load Balancer (optional if more than one WEB/APP server running the application); appropriate switches and routers; electrical Power (backup power); Network Backup hardware and software, and a check scanner.

The application can run the Secure Sockets Layer (SSL) protocol. The WEB/APP Server can be a 1 GHZ PIII or PIV, or dual processor PIII or PIV at 600 MHZ, with 2 GIG of RAM, 20 GIG Raid level 1, 100 Megabit or 1 GHZ network connection, and DAT 12/24 Backup system. The Database Server can be a Dual Processor XEON 800 or Single Processor 1.8 GHZ PIV with 1 GIG of RAM, ON-Board 18 GIG at Raid level 1, either on-board or external disk array running raid level 3, with 3-36 GIG hard drives, and 100 GIG active backup system, capable of backing up and restoring while the system is active. The system software can be a WEB/APP Server—running Windows 2000 , or Windows 2000 Advanced Server for dual processor machine; a Database Server—running Windows 2000 Advanced Server and SQL Enterprise Edition for dual processor machine or an active/passive configuration for redundancy.

Initially, a use parameter can be established at the system creation level utilizing a database encrypted default setting script. This parameter will be to enable or disable remote deposit. The default value can be “No”. If the default value at the system creation level is “Yes”, this option can be enabled at the system level. If the value is changed to “Yes” at the system level, the financial institution can enable a Remote Deposit Category and/or Remote Deposit File Load for any Customer (Originator)/branch.

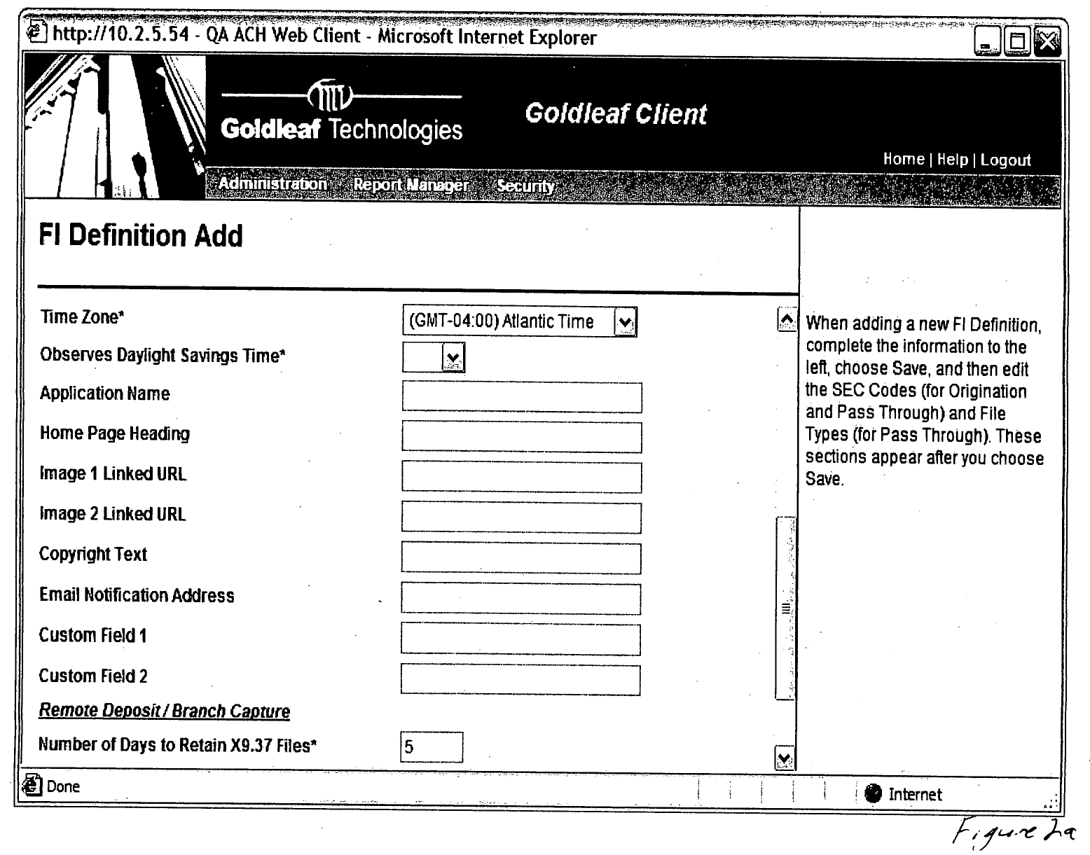

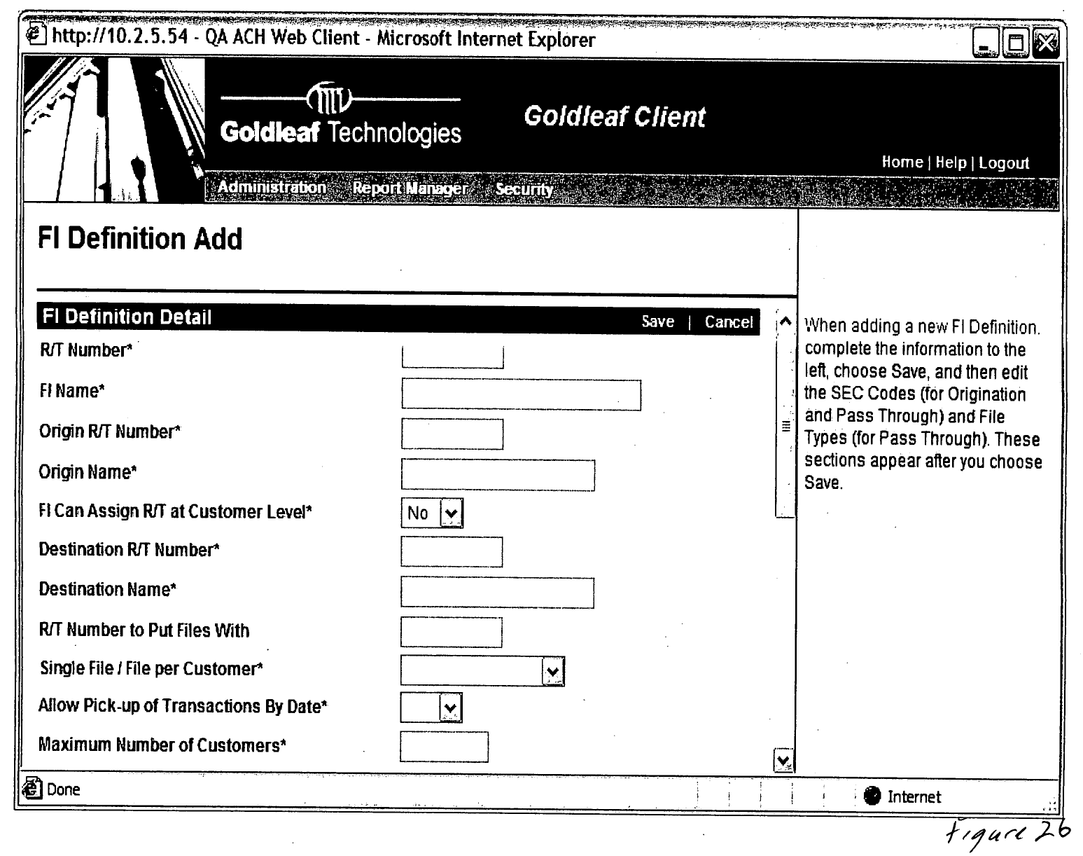

Next, the system level is set up. Referring to FIGS. 2a and 2b, the financial institutions are provided a FI Definition Add screen. The FI Definition Add screen can include Time Zone, Application Name, Home Page Heading, Image Linked URL, Copyright Text, e-Mail Notification Address, Custom Fields, Number Of Days To Retain X9.37 Files, R/T Number, FI Name, Origin R/T Number, Origin Name, FI Can Assign R/T at Customer Level, Destination R/T Number, Destination Name, R/T Number to Put Files With, Single File/File per Customer, Allow Pick-up of Transactions by Date, and Maximum Number of Customers fields for the financial institution to fill in.

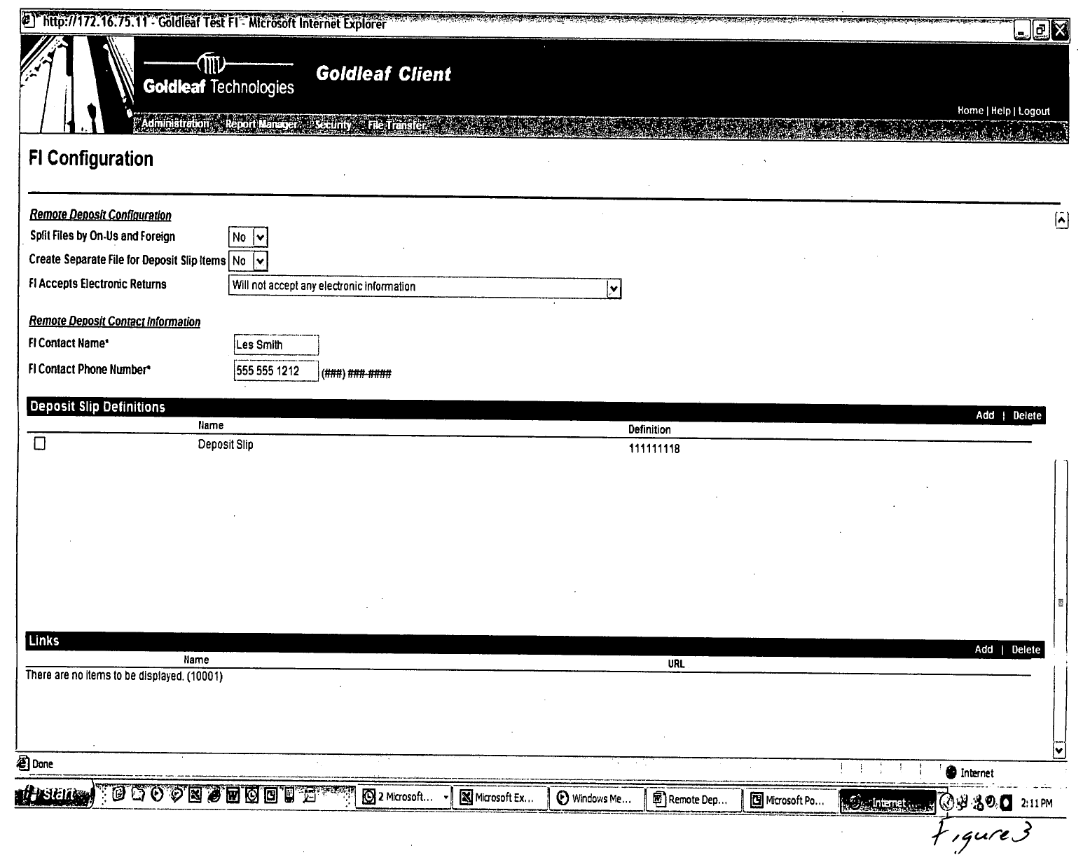

Referring to FIG. 3, a FI Configuration screen is seen. The financial institution enters in the information that will control the way the application will manage the plitting of X9.37 files into separate logical files representing Deposit Slips, on-us transactions and transit (non on-us) transactions and the method of handling electronic returns. The FI Configuration screen can include a Remote Deposit Configuration section having Split Files by On-Us and Foreign, Create Separate File for Deposit Slip Items, and FI Accepts Electronic Returns fields. The FI Configuration screen further can include a Remote Deposit Contact Information section having FI Contact Name and FI Contact Phone Number fields. A Deposit Slip Definitions and Links fields are provided. Selecting ‘Add’ in the Deposit Slip Definition filed links to a FI Deposit Slip Definition Add pop-up screen.

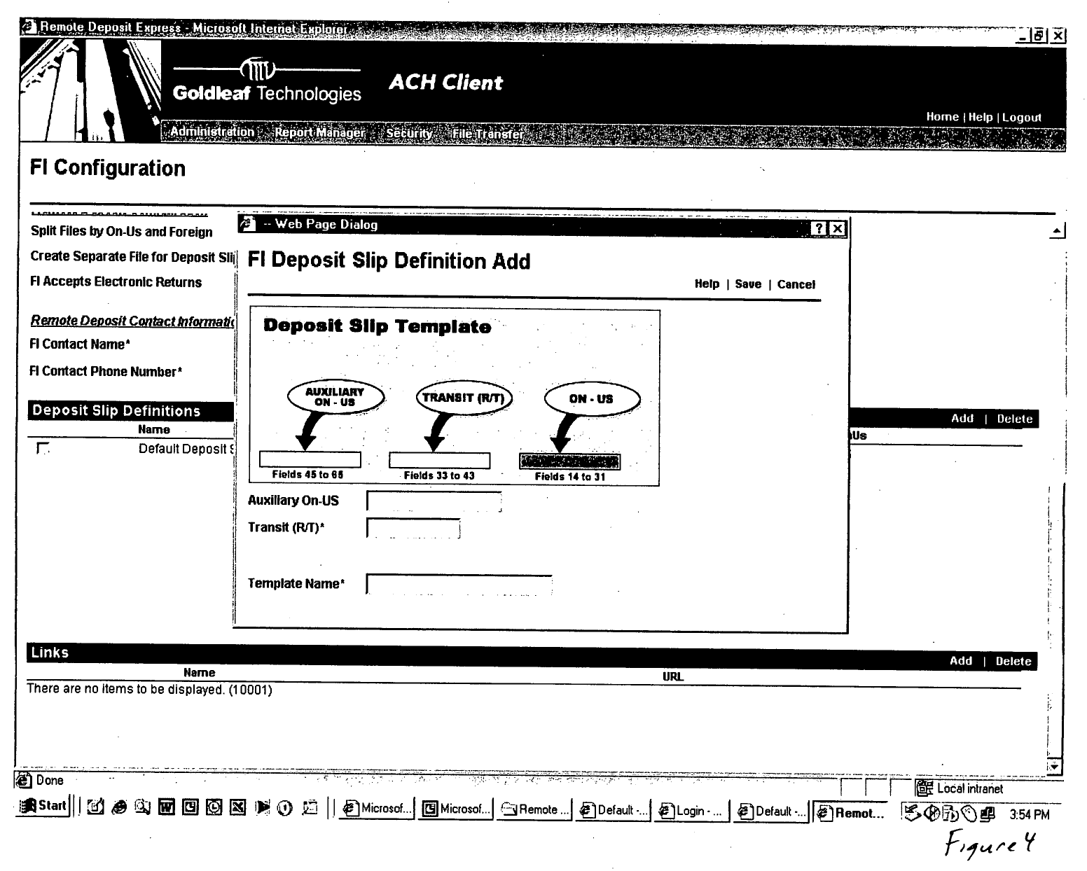

Next, referring to FIG. 4, a FI Deposit Slip Definition Add pop-up screen is seen. One or more Deposit Slip definitions are created. Deposit Slip definitions allow for virtual representations of the physical deposit slips used by financial institutions with their customers. A Deposit Slip Template section can include Auxiliary On-Us and Transit (R/T) fields. A Template Name field can also be provided.

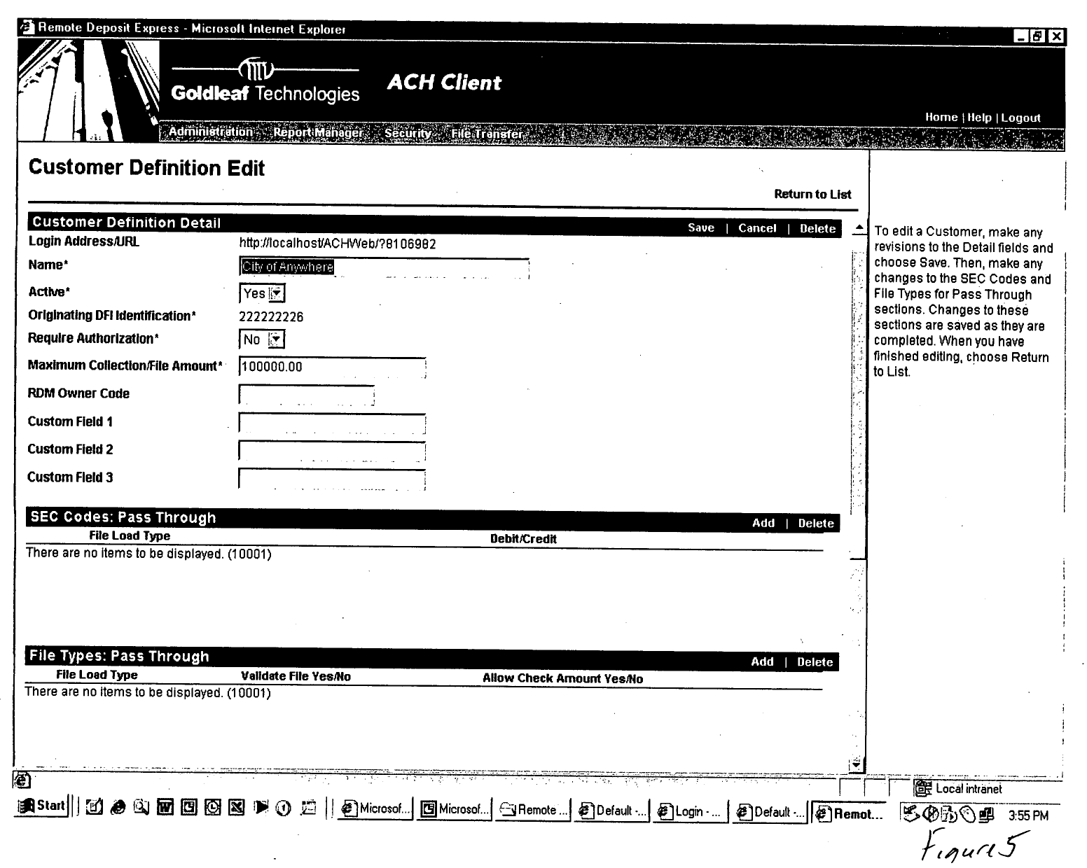

Next, referring to FIG. 5, a Customer Definition Edit screen is seen. The customer specific information is entered to allow a customer access to the application. The Customer Definition Edit screen can include a Customer Definition Detail section having Login Address URL, Name, Active, Originating DFI Identification, Require Authorization, Maximum Collection/File Amount, RDM Owner Code and Custom Fields. The Customer Definition Edit screen further can include SEC Codes: Pass Through and File Types: Pass Through sections.

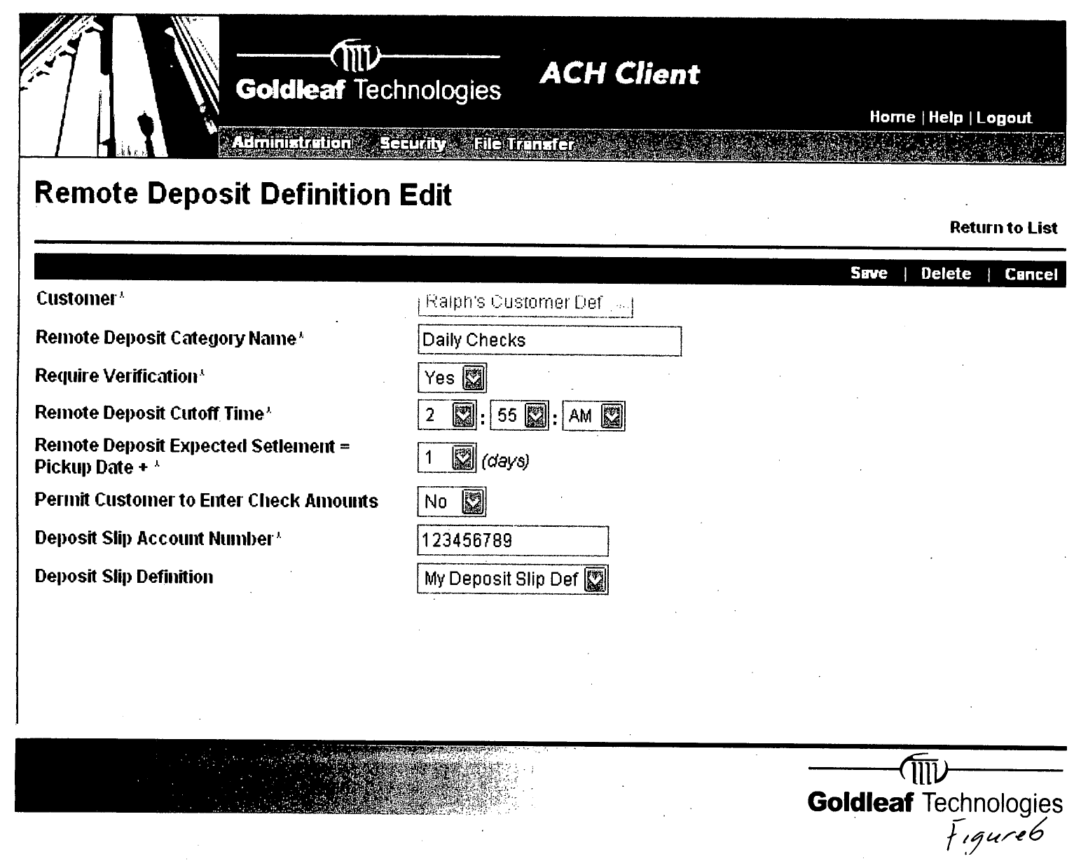

451 Referring to FIG. 6, a Remote Deposit Definition Edit screen is seen. The Remote Deposit Definition Edit screen allows the financial institution to customize the Remote Deposit application for each customer allowed to access the system. The Remote Deposit Definition Edit screen can include Customer, Remote Deposit Category Name, Require Verification, Remote Deposit Cutoff Time, Remote Deposit Expected Settlement=Pickup Date+, Permit Customer to enter check Amounts, Deposit Slip Account Number, and Deposit Slip Template fields. Remote Deposit Cutoff Time can be added as a drop down box to include hours (i.e. 1-12), minutes (00-60), and (AM/PM). The Remote Deposit Expected Settlement equals the financial institution Pickup Date plus a drop down box including for example days 0-20. If file is picked up by a financial institution after the financial institution's system specified cutoff time, for settlement calculation purposes, the base date can be moved to the next business day. An option to Permit Customer to Enter Check Amounts can be provided, having a default value of “No”.

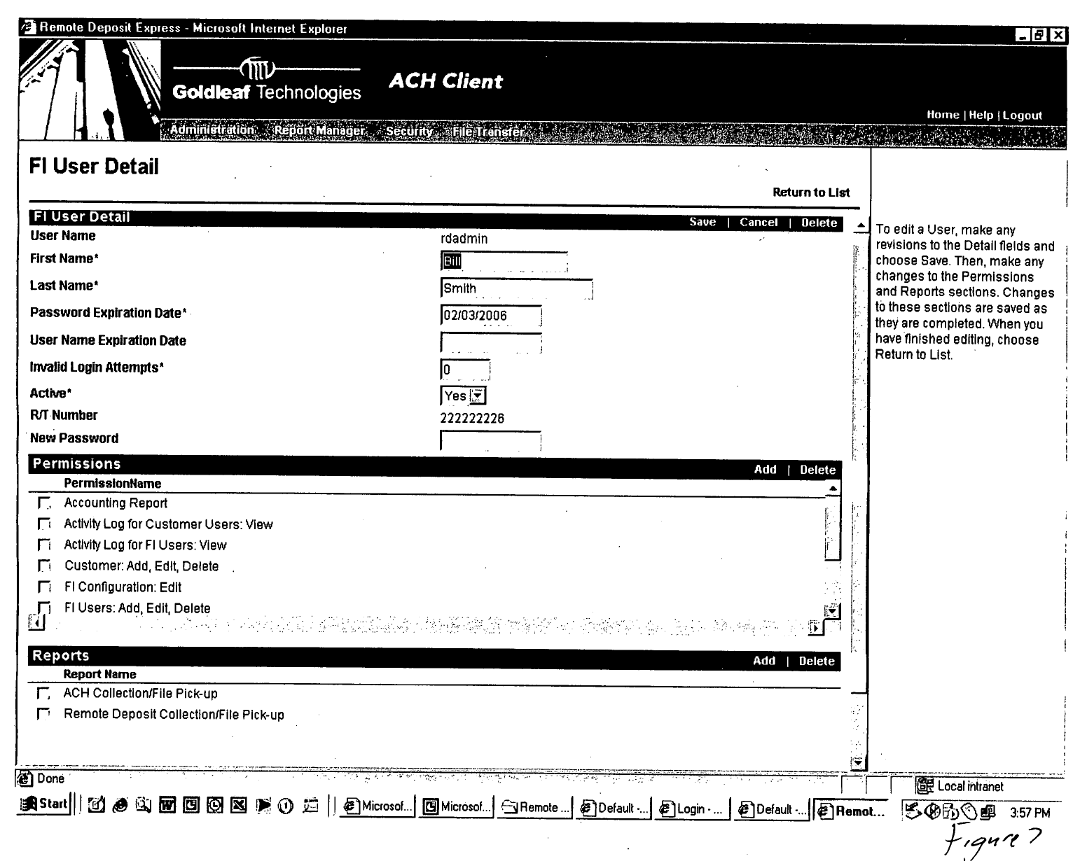

Next, a financial institution user is setup. Referring to FIG. 7, a FI User Detail screen is seen. A financial institution permissions file can be created. Separate File Transfer Permissions are created covering aspects of application usage. The application pages are dynamically built showing the user functionality for which they have been granted permissions. The FI User Detail screen can include a FI User Detail section having User Name, First Name, Last Name, Password Expiration Date, User Name Expiration Date, Invalid Login Attempts, Active, R/T Number, and New Password fields. The FI User Detail screen can further include a Permissions section having Accounting Report, Activity Log for Customer Users: View, Activity Log for FI Users: View, Customer: Add, Edit, Delete, FI Configuration: Edit, and FI Users: Add, Edit, Delete options. The FI User Detail screen can further include a Reports section having an ACH Collection/File Pick-up and Remote Deposit Collection File Pick-up options. An additional embodiment will allow permission as to whether the financial institution user can perform “Check Repair.”

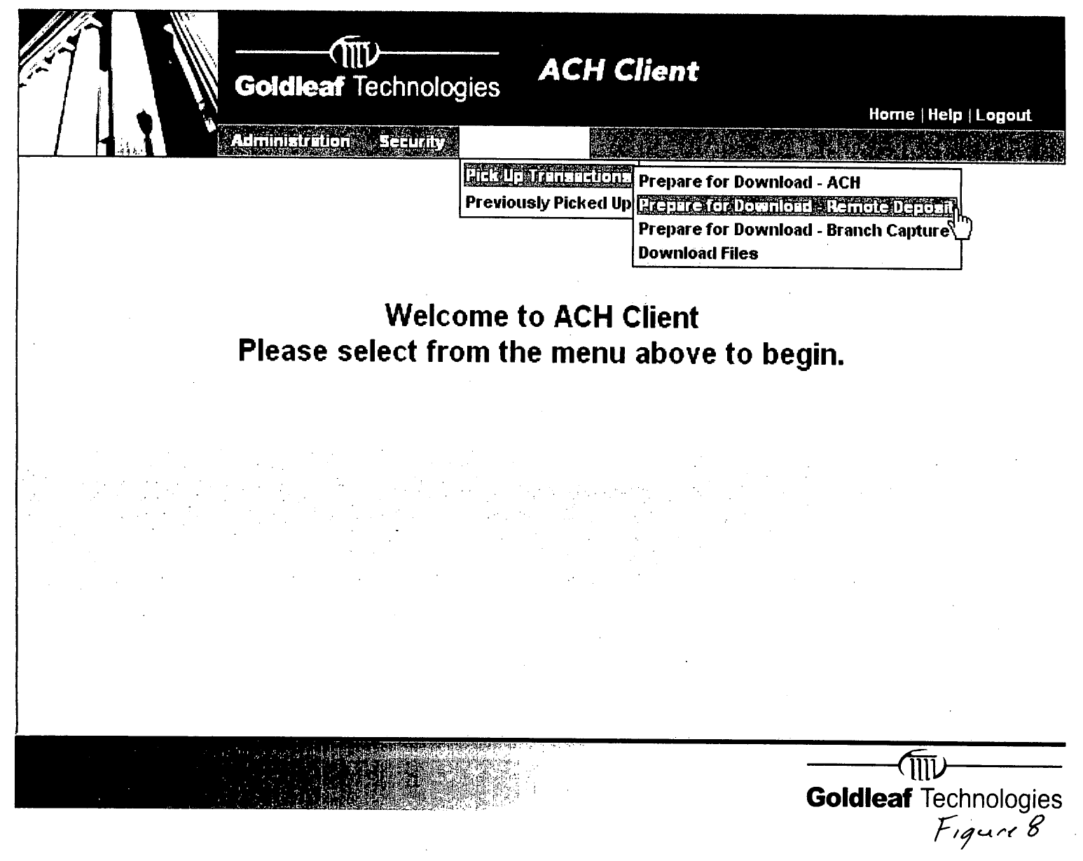

a customer user is setup. A customer permissions file can be created. Separate File Transfer Permissions are created covering all aspects of application usage. The application pages are dynamically built only showing the user functionality for which they have been granted permissions. Referring to FIG. 8, a Financial Institution Administration Menu home page is seen. The Financial Institution Administration Menu home page can include Administration, Security, and File Transfer drop-down menus. The File Transfer drop-down menu can include Pick Up Transitions and Previously Picked Up links. The Pick Up Transactions links to Prepare for Download—Remote Deposit, Prepare for Download—Branch Capture, and Download Files links. Selection of the Prepare for Download—Remote Deposit links to a Pick Up Transactions—Remote Deposit screen.

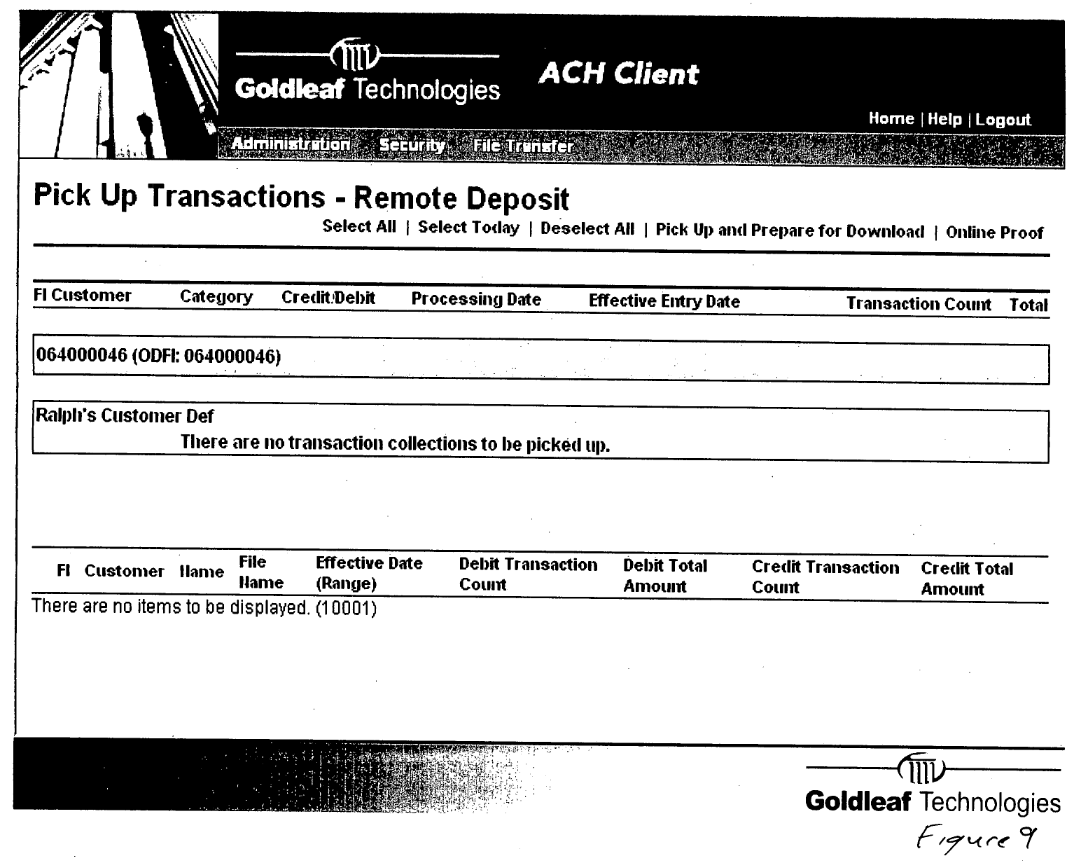

Next, transaction processing by a financial institution is provided. Referring to FIG. 9, a Pickup Transactions—Remote Deposit screen is provided. A pickup section for remote deposit is displayed only if Remote Deposit Category has been established. If remote deposit is enabled for the financial institution and there are remote deposit customers enabled, a separate remote deposit pickup section can be provided: Files can be segregated into Deposit Slips, On-us Files and Foreign Files. The purpose of the remote deposit sections is to alert a financial institution that it has Remote Deposit Files that require routing through check processing.

In the additional embodiment that will allow a permission as to whether the financial institution user can perform “Check Repair”, a financial institution user with “Check Repair” permission can select Check Repair in the menu, pick from the list of collections awaiting check repair, and quickly enter check amounts for each transaction as the check image appears.

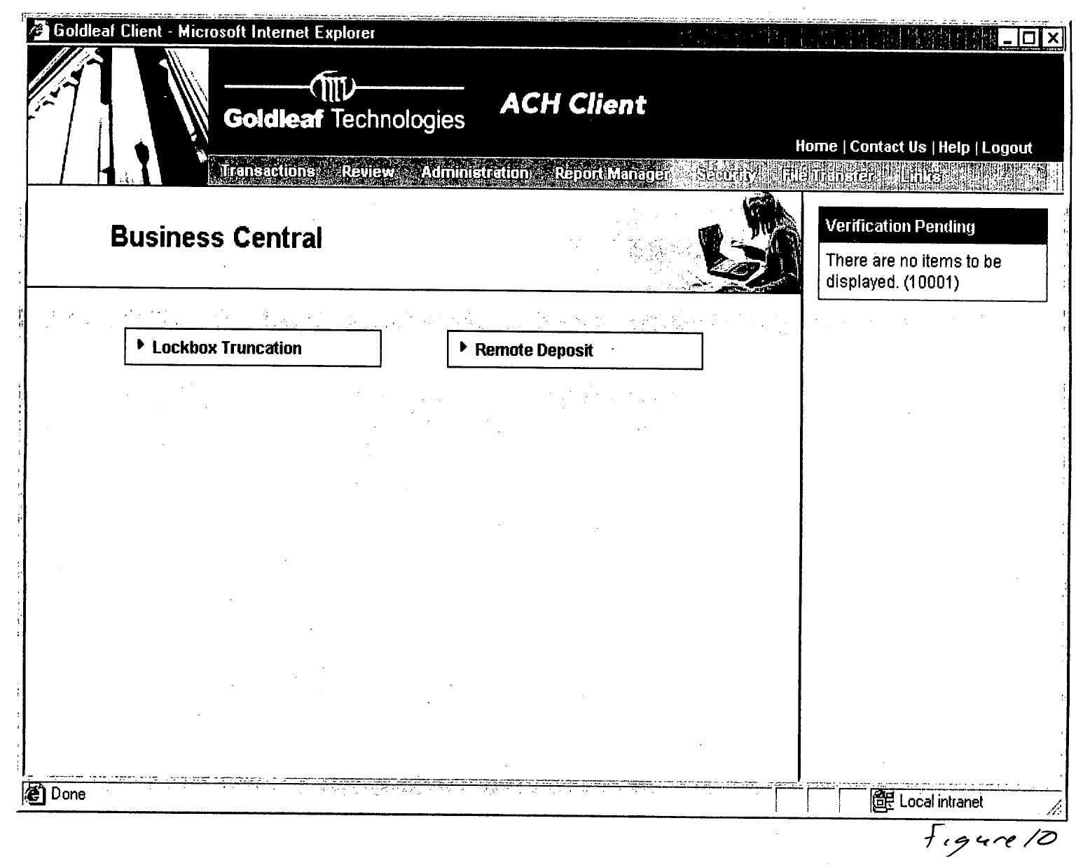

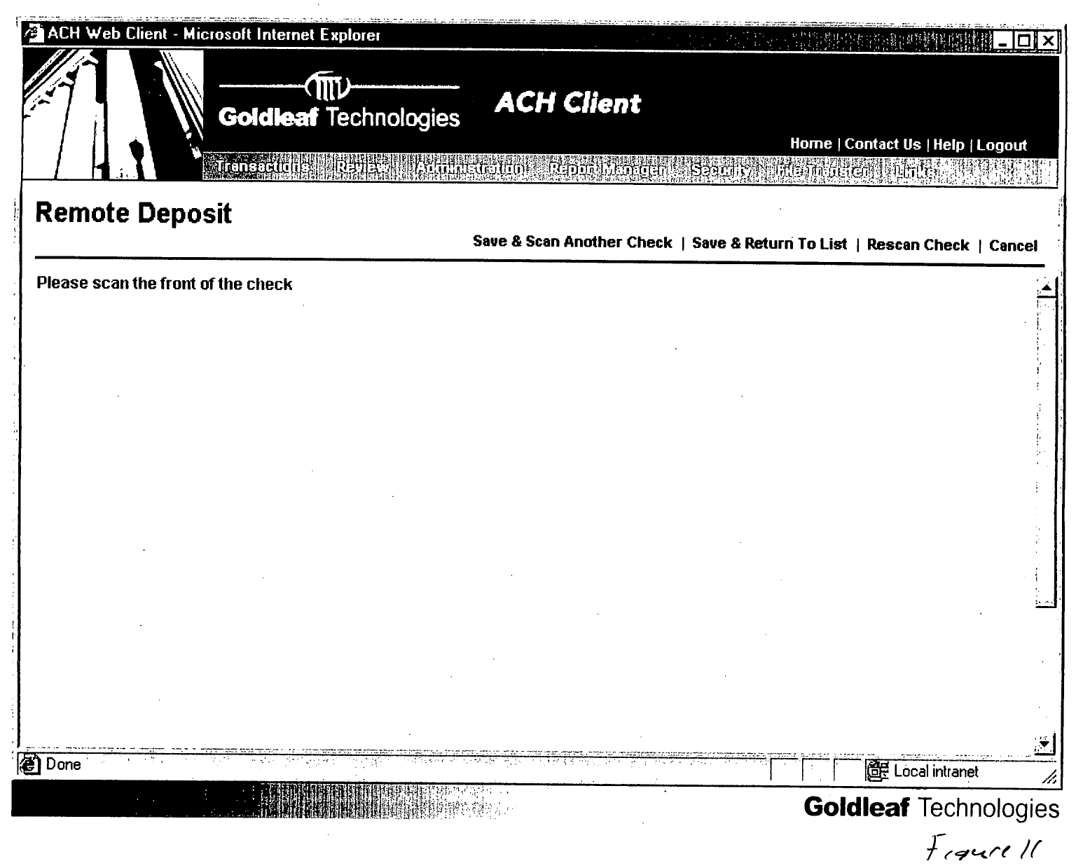

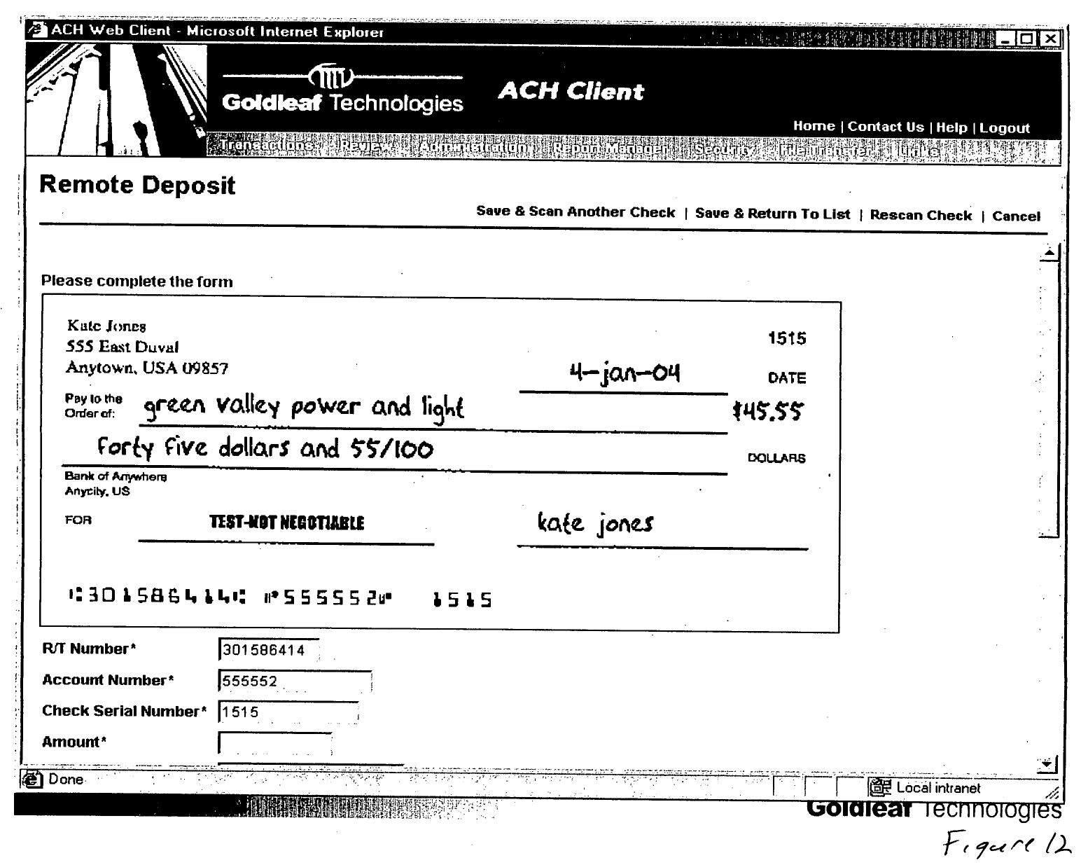

Next, referring to FIGS. 10-13, customer check capture is provided. Remote Deposit Customer Transaction can be created. FIG. 10 shows a screen which acts as the customer home page. The customer can select Remote Deposit. The Remote Deposit instruction screen seen in FIG. 11 instructs the customer to scan the check. The front of a check is scanned. The Remote Deposit form, seen in FIG. 12, is completed (note, not all of the fields described can be seen in FIG. 12).

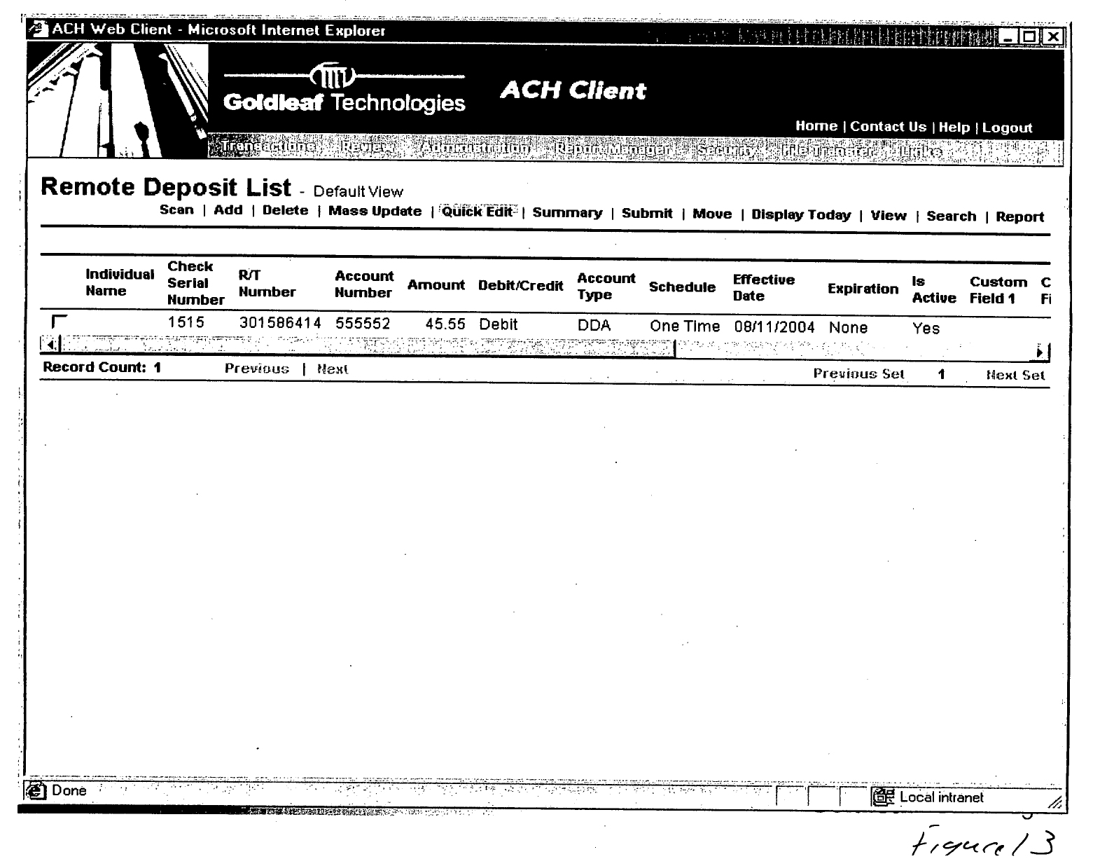

The name of the individual, which is not a required field, can be an information only field and is not a part of the transaction file. Check Serial Number is not required, and may or may not be captured as it is dependent upon the type of check scanned. Debit/Credit, which is not applicable, does not display on an entry screen. Account Type, which is not applicable, does not display on an entry screen. Effective Date is replaced by Origination Date, which can be system generated and added to the transaction field at save. There is no stale date test in Submission, and there are no Look Ahead Days. Any active transaction in the list is eligible to Submit (any scan date can be submitted, verified and authorized). Schedule is not applicable. Expiration is not applicable. Is Active can default to “Yes”. Is Active changes to “No” after transaction is authorized the same as any other one-time transaction. Custom Fields 1, 2, and 3, and notes fields are available as information fields only, and are not a part of the transaction file. Image Quality Engine can be initiated at item scan, and provides data to populate a specifically defined record within the X9.37 file that alerts all entities that will process the check image as to the status of the image quality for the transaction. As seen in FIG. 13, the results of the customer check capture are displayed in a Remote Deposit List screen. An image that fails the image quality test will receive a rescan check message, and a transaction cannot be created until the image passes.

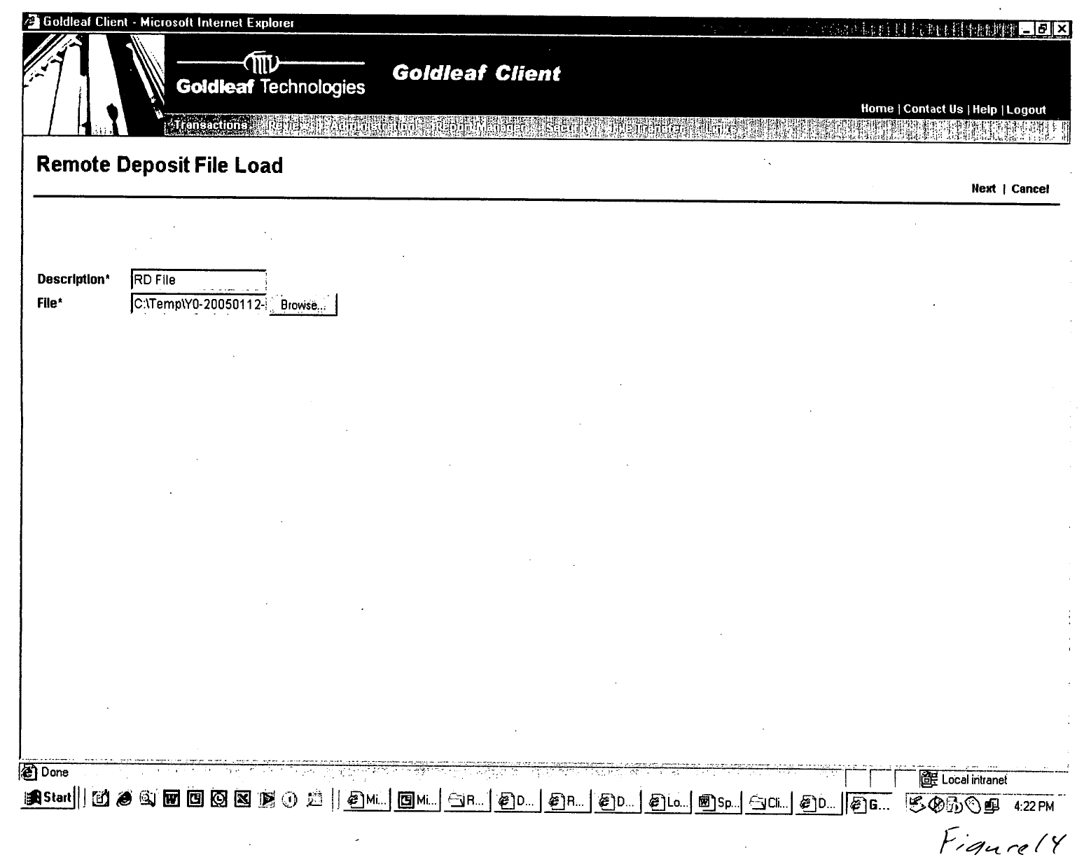

Referring to FIG. 14, a Remote Deposit File Load screen that enables customer file load is seen. At the Main Menu, Load File submenu under File Transfer provides a Remote Deposit File type. The Federal Reserve Bank sets a maximum permitted file size. Any loaded files exceeding the Federal Reserve Bank maximum are rejected, with an error message: File size exceeds Federal Reserve Bank maximum.

If Remote Deposit Validation is set to “No” at the financial institution level, the system will validate only the minimum required fields for 1) Security; 2) Risk; and 3) to permit the system administrator and the financial institution to build the Accounting Report to support billing purposes. Based on a financial institution's Customer Definition setting, 1) the Check 21 formatted file is validated per (X9.37) and an invalid file is rejected; or 2) the Check 21 file is not validated and a Pass Through of an invalid file is permitted only if there is valid data contained in the fields described below. There is no option to pick and choose which of the file structure/values are validated.

The file is either validated according to X9.37 standards or it is not validated. Valid X9.37 file representations are EBCDIC and/or ASCII, but are dependent upon a financial institution's Customer Definition setting of acceptable type. An error can be provided when rejecting a file for bad or incorrect data. The validation is not stopped on first error: the entire file can be validated and a summary can be provided. Fields/location, etc. are identified as necessary to guide customer as to specifics of the error. The system will permit a file to pass through if the financial institution's Remote Deposit Definition is set to “No” for Validate File and the following fields can be identified and validated: File Creation Date; Originator ID; Debit Totals (totals match to file record); Number of Transactions (count matches to file record); Remote Deposit File Load, Remote Deposit File Load Confirm; and Remote Deposit File Load Confirmation.

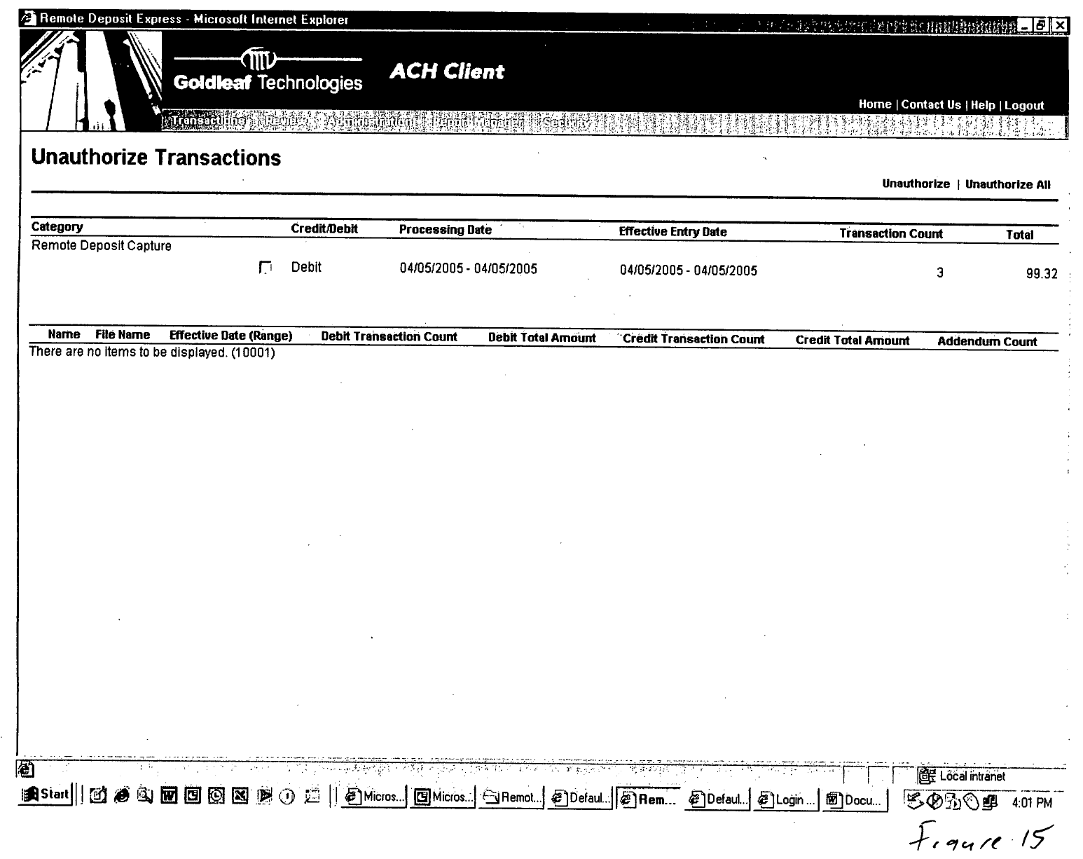

Transaction and File Verification and Authorization include Remote Deposit Category in Verification/Authorization. In Transaction and File Unauthorization, an Unauthorize Transactions screen is seen in FIG. 15. The Unauthorize Transactions screen can be modified to match a financial institution Pickup screen (add remote deposit and branch capture collection and pass through sections). The Image Quality Engine is limited to system created transactions, does not perform quality tests on Pass-Through files, and does not populate the specifically defined record within the X9.37 file that alerts all entities that will process the check image as to the status of the image quality. Image quality of a Pass-Through file is the responsibility of the originating software.

The file specifications are in accordance with the American National Standards Institute (ANSI) Draft Standard for Trial Use (DSTU) X9.37-2003 Specifications for Electronic Exchange of Check and Image Data. Acceptable file representations are EBCDIC (required by the Federal Reserve Bank) and ASCII for Pass Through files if enabled by the financial institution. (See Federal Reserve Adoption of DSTU X9.37-2003 Image Cash Letter Customer Documentation, Version 1.1 of Jul. 1, 2004. Federal Reserve Adoption is a clarification for Federal Reserve purposes of the DSTU X9.37-2003 specification.) For Pass Through files only, file validation includes verification that a transaction's image MICR is identical to the transaction record.

System Creation Setup can be administered by a database encrypted default setting script. A Remote Deposit option is provided, with a default of “No”. A financial institution user's Add, Edit, Delete Permission will access the financial institution Definition List. Add is selected for a new financial institution, or any field can be selected in the financial institution's row to edit an existing financial institution.

Remote deposit can be enabled at the Remote Deposit form (the Remote Deposit form is seen in FIG. 12; however, the remote deposit enable fields are not shown). The remote deposit is enabled in the Remote Deposit section, Remote Deposit Origination can be added. Remote Deposit File is added to the section File Types: Pass Through. Acceptable X9.37 file representation, EBCDIC (Federal Reserve Bank standard), ASCII, or both are added.

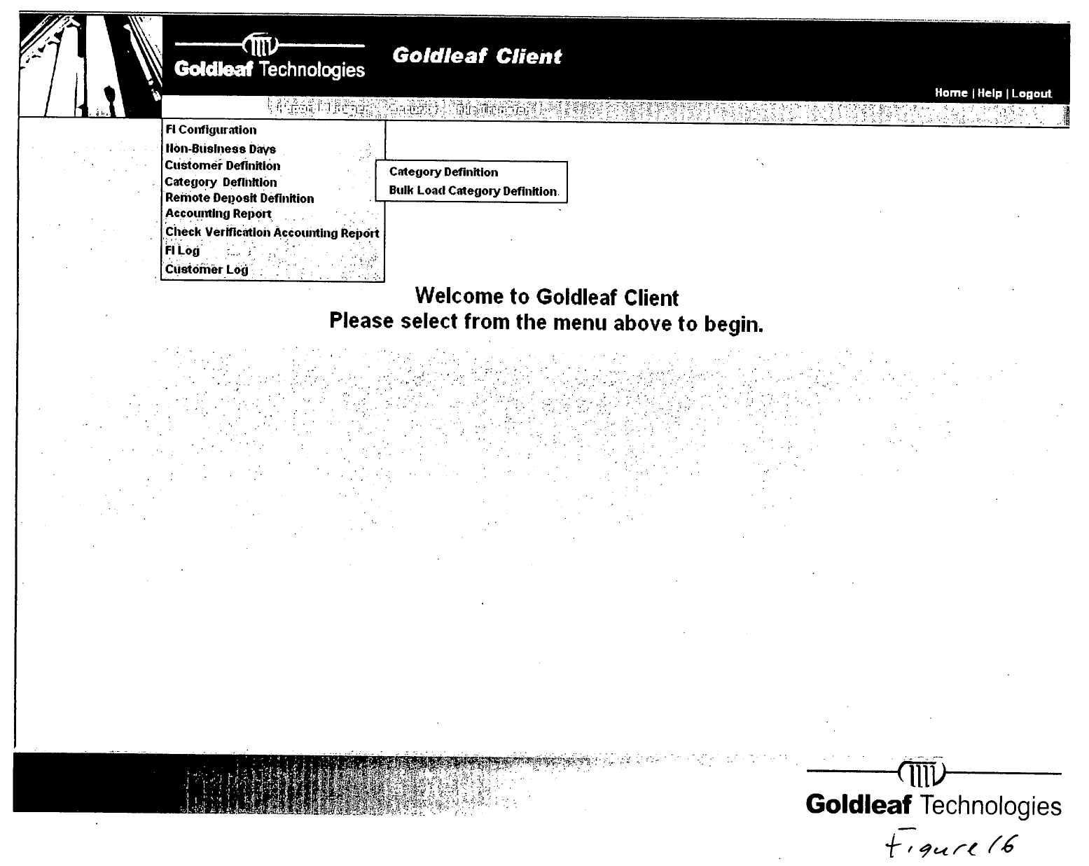

Next, the financial institution remote deposit can be setup. At the Home Page, a financial institution user with Customer Add, Edit, and Delete Permission will select Administration from the Main Menu. Referring to FIG. 16, the Financial Institution Administration Menu home page screen is again seen. The Administration drop-down menu can include FI Configuration, Non-Business Days, Customer Definition, Category Definition, Remote Deposit Definition, Accounting Report, Check Verification Accounting Report, FI Log, and Customer Log links. Customer Definition can be selected. At the Customer Definition List, Add can be selected for a new customer, or any field in the customer's row can be selected to edit an existing customer. RDM Owner Code is entered for any remote deposit and/or branch capture customer, as it is required to scan checks.

Remote deposit can be enabled at a Customer Definition Add/Edit screen as follows: In remote deposit and/or branch capture section, Remote Deposit Origination can be added; Remote Deposit File can be added to the section File Types: Pass Through; the acceptable file representations are selected from drop down menu (the options are EBCDIC and ASCII); and the setup information or edit field(s) are saved. From the Main Menu, Remote Deposit Definition can be selected. Referring back to FIG. 5, Customer Definition Edit screen Add can be selected or, to edit an existing remote deposit setup, Remote Deposit can be selected. Referring to FIG. 6, the Remote Deposit Definition Edit screen is seen. If a new remote deposit is being added, the applicable Definition screen will appear. If remote deposit is being edited, the applicable Definition screen will appear when it is selected.

Next, the customer is selected from the Dropdown List. The Originator ID (needed for internal processing and control) is entered. Remote deposit is entered. An option to Require Verification can be provided from a dropdown list, with a default of “Yes”. Selecting “No” permits a submitted or loaded file to bypass Verify and Authorize steps if the user has been established with sufficient authority (verify and dollar limitation checks, etc.). An option to allow Check Scanning can be provided, with a default of “Yes” (which does not appear on this screen). Permitted Account Types and Addenda Exclusions are not applicable to remote deposit and do not appear on the screen. When completed, save is selected and the user returns to the Remote Deposit Definition List.

Referring back to the Home screen which acts as the customer home page in FIG. 10, for Customer Setup, at the customer home page, a customer user with Remote Deposit Configuration with Edit permission can select Administration from the Main Menu. For customer security, at the Main Menu (seen in FIGS. 8 and 15) customer users are selected. At a Customer Users List screen, Add can be selected for a new user or an existing user can be selected to edit. Remote Deposit Configuration can be added and the user's permissions can be edited. Remote Deposit Authority can be added to the user's authorities. Remote Deposit File can be added to the user's File Load Type Authorities. When finished, save is selected and the user returns to the Customer Users List screen.

To create and process transactions, a financial institution with Remote Deposit File Transfer Authority will see the remote deposit collections and files. Otherwise, remote deposit items will not be displayed to this financial institution user. From the Main Menu, File Transfer can be selected. From a dropdown menu, Pick Up Transactions can be selected. From a submenu, Prepare For Download can be selected. Remote Deposit Collection section can be scrolled to if picking up system created files. The collection(s) to be downloaded are marked (or Select All can be chosen from the screen menu to pick up all collections and files). Pick Up and Prepare for Download can be selected. Remote Deposit File section can be scrolled to if picking up loaded (Pass Through) files. The file(s) to be downloaded are selected (or choose Select All from the menu to pick up all collections and files). Pick Up and Prepare for Download can be selected. From the Download File screen, the file(s) to be downloaded are marked (or Select All can be chosen from the screen menu). Download can be selected, and the download proceeds using the File Download dialog box.

To create a Customer Transaction, transactions must be scanned into the Transaction List. An image of the front and back of the check is a required component of the X9.37 file format. Although the front and back images are required, the Remote Deposit Configuration will permit the following scan options: Scan Front and Save Image (for use with RDM Archive Service); Scan Front/Back And Save Image (for use with RDM Archive Service); Scan Front and Do Not Save Image (not currently a valid option as X9.37 format for IRD requires both front and back of image); and Scan Front and Back and Do Not Save Image (saves image as part of X9.37 file only).

From the Remote Deposit Transaction List menu, Scan can be selected. Begin Scanning Checks is selected. The check is inserted in scanner face up when the message appears: “Please scan the front of the check.” The check is inserted in scanner backside up when the message appears: “Please scan the back of the check.” The form is completed when the message appears: “Please complete the form.” Required fields are indicated by an asterisk (*). The only required field not read from the check MICR is amount. In a first embodiment, if the amount field has not been encoded on the item, this amount is manually entered. In a further embodiment, a system in accordance with the principles of the present invention can scan the amount field(s) and automatically enter the amount. All others are optional for internal research assistance, and do not travel with the transaction. There is no effective date field. The effective date is replaced by origination date, and no stale date test occurs. Any scan date can be submitted, verified, and authorized. Save and Scan Another Check or Save and Return To List can be selected. Rescan Check is available for MICR read or image errors.

All checks are eligible for remote deposit, including business, government, counter checks, money orders, Cashier's Checks. Check serial number is not a required field for remote deposit. Any transaction field can be edited. Extraneous dashes are removed from the MICR data per Federal Reserve Adoption of DSTU X9.37-2003 Image Cash Letter Customer Documentation, Version 1.1 of Jul. 1, 2004.

In one embodiment, image archival option can be available on the RDM archive site (exactly like ARC, Point of Purchase, and Re-Presented Check). RDM image archival is independent of the Check 21 IRD specifications. Images that are part of the IRD are stored as part of the Check 21 file format, and only until they are no longer available from the Previously Picked Up Transactions and Files screen, which can be a system configurable number of days after the financial institution picks up. If RDM image archival is provided, a check image can be viewed in the Transaction List by selecting View in the transaction's Check Image column.

Any active transaction in the Transaction List is eligible for Submission. Transaction's “Is Active” status can be changed from “Yes” to “No” the same as other one-time transactions. Verification and Authorization process for remote deposit can be consistent with other transaction collections and files. Unauthorized transactions/files process for remote deposit can be consistent with other transaction collections and files.

Because the system and financial institutions may be pricing remote deposit transactions differently than ACH files, a reporting section titled “Remote Deposit” can be included. The “Remote Deposit” reporting section includes system created transactions, and Pass Through files subsections containing same information as with SEC Codes and ACH file Pass Through files. Modifications to all Accounting Reports are required to classify the Remote Deposit Category with available Image Archival options.

While the invention has been described with specific embodiments, other alternatives, modifications and variations will be apparent to those skilled in the art. For example, depending on the particular needs of an investment a financial instrument in accordance with the present investment can be combined with other financial instruments in a single offering. Accordingly, it will be intended to include all such alternatives, modifications and variations set forth within the spirit and scope of the appended claims.

What is claimed is:

1. A system to deposit financial instruments to a financial institution remotely, comprising:
capturing the image of the financial instrument, including associated Magnetic Ink Character Recognition (MICR) data;
entering an amount of the financial instrument;
converting the image of the financial instrument and related MICR data into American National Standards Institute (ANSI) standard for electronic exchange among financial institutions and processors in a transaction/file;
the financial institution picking up the transaction/file via an Internet connection; and
the financial institution processing the file using check processing system or service.

2. The system of claim 1 further wherein the step of picking up the transaction/file via an electronic connection comprises picking up the transaction/file via an online connection which allows individual or collective accumulation of the transaction data into one or more X9.37 formatted file.

3. The system of claim 1 further including batching and submitting multiple items for pickup by the financial institution.

4. The system of claim 1 further wherein the step of entering an amount of the financial instrument comprises manually entering an amount of the financial instrument.

5. The system of claim 4 further wherein the step of manually entering an amount of the financial instrument can be performed by a customer.

6. The system of claim 4 further wherein the step of manually entering an amount of the financial instrument can be performed by the financial institution.

7. The system of claim 1 further wherein the step of entering an amount of the financial instrument comprises scanning the amount field(s) and automatically entering the amount

8. The system of claim 1 further providing the financial institution with the ability to perform financial instrument repair.

9. The system of claim 8 further providing the financial institution with the ability to correct financial instrument amounts as a part of the review/repair of the financial instrument.

10. The system of claim 1 further wherein the American National Standards Institute (ANSI) standard for electronic exchange of checks and check data among financial institutions and processors comprises the X9.37 format.

11. The system of claim 1 further wherein the financial instrument is selected from the group comprising checks, money orders, cashier's checks, deposit slips, general ledger tickets, any non-check item that includes a MICR line, and combinations thereof.

12. The system of claim 1 further providing an EBCDIC file representation.

13. The system of claim 1 further providing an ASCII file representation.

14. The system of claim 1 further providing check franking.

15. The system of claim 1 further providing image archival.

16. A system to deposit financial instruments to a financial institution remotely, comprising:
electronically truncating the financial instrument at the business site;
depositing the financial instrument online; and
the financial institution picking up the financial instrument as a ‘Check 21 file’ in X9.37 format.

17. The system of claim 16 further wherein the step of electronically truncating the financial instrument at the business site comprises capturing the image of the financial instrument, including associated Magnetic Ink Character Recognition (MICR) data; entering an amount of the financial instrument; and converting the image of the financial instrument and related MICR data into American National Standards Institute (ANSI) standard for electronic exchange among financial institutions and processors in a transaction/file.

18. The system of claim 17 further wherein the step of entering an amount of the financial instrument comprises manually entering an amount of the financial instrument.

19. The system of claim 18 further wherein the step of manually entering an amount of the financial instrument can be performed by a customer.

20. The system of claim 18 further wherein the step of manually entering an amount of the financial instrument can be performed by the financial institution.

21. The system of claim 17 further wherein the step of entering an amount of the financial instrument comprises scanning the amount field(s) and automatically entering the amount

22. The system of claim 17 further wherein the American National Standards Institute (ANSI) standard for electronic exchange of checks and check data among financial institutions and processors comprises X9.37 format.

23. The system of claim 16 further including batching and submitting multiple items for pickup by the financial institution.

24. The system of claim 16 further providing the financial institution with the ability to perform financial instrument repair.

25. The system of claim 24 further providing the financial institution with the ability to correct financial instrument amounts as the financial instrument image appears.

26. The system of claim 16 further wherein the financial instrument is selected from the group comprising checks, money orders, cashier's checks, deposit slips, general ledger tickets, any non-check item that includes a MICR line, and combinations thereof.

27. A system to deposit financial instruments to a financial institution remotely, comprising:
capturing a customer deposit at the place of business of the customer;
converting the Magnetic Ink Character Recognition (MICR) data encoded documents into an image with an associated data file; and
electronically transmitting the data to the financial institution.

28. The system of claim 27 further wherein the step of capturing a customer deposit at the place of business of the customer comprises capturing the image of the financial instrument, including associated Magnetic Ink Character Recognition (MICR) data and entering an amount of the financial instrument.

29. The system of claim 27 further wherein the MICR data can be converted into American National Standards Institute (ANSI) standard for electronic exchange among financial institutions and processors.

30. The system of claim 29 further wherein the American National Standards Institute (ANSI) standard for electronic exchange of checks and check data among financial institutions and processors comprises X9.37 format.

31. The system of claim 27 further including the financial institution picking up the transaction/file in the same manner that Automated Clearing House (ACH) Network transactions/files are picked up.

32. The system of claim 27 further including batching and submitting multiple items for pickup by the financial institution.

33. The system of claim 27 further including online capturing of the MICR data and the associated image.

34. The system of claim 27 further including offline capturing and the subsequent importing of the image and MICR data for transmission to the financial institution.

35. The system of claim 27 further including entering an amount of the financial instrument.

36. The system of claim 35 further wherein the step of entering an amount of the financial instrument comprises manually entering an amount of the financial instrument.

37. The system of claim 36 further wherein the step of manually entering an amount of the financial instrument can be performed by a customer.

38. The system of claim 36 further wherein the step of manually entering an amount of the financial instrument can be performed by the financial institution.

39. The system of claim 35 further wherein the step of entering an amount of the financial instrument comprises scanning the amount field(s) and automatically entering the amount

40. The system of claim 27 further providing the financial institution with the ability to perform financial instrument repair.

41. The system of claim 40 further providing the financial institution with the ability to correct financial instrument amounts as the financial instrument image appears.

42. The system of claim 27 further wherein the financial instrument is selected from the group comprising checks, money orders, cashier's checks, deposit slips, general ledger tickets, any non-check item that includes a MICR line, and combinations thereof.
